(19) United States
(12) Patent Application Publication
(10) Pub. No.: US 2019/0021064 A1
(43) Pub. Date: Jan. 17, 2019

(54) METHOD FOR MANAGING REGISTRATION IN WIRELESS COMMUNICATION SYSTEM AND DEVICE FOR SAME

(71) Applicant: LG ELECTRONICS INC., Seoul (KR)

(72) Inventors: Jinsook RYU, Seoul (KR); Sangmin PARK, Seoul (KR); Sungduck CHUN, Seoul (KR)

(73) Assignee: LG ELECTRONICS INC., Seoul (KR)

(21) Appl. No.: 16/065,107

(22) PCT Filed: Jul. 4, 2017
(86) PCT No.: PCT/KR2017/007095

§ 371 Date: Jun. 21, 2018

Related U.S. Application Data
(60) Provisional application No. 62/358,057, filed on Jul. 4, 2016.

(51) Int. Cl. H04W 60/06; H04W 60/04; H04W 76/27; H04W 68/00

(52) U.S. Cl. CPC H04W 60/06; H04W 60/04; H04W 84/042; H04W 68/005; H04W 76/27

(57) ABSTRACT

A method for managing registration in a wireless communication system and a device for the same are disclosed. More specifically, the method for managing registration performed by a User Equipment (UE), that cannot be paged by a network and does not perform a periodic registration area update, in the wireless communication system, may include receiving a timer value for managing a Deregistered state of the UE from the network during a registration procedure, starting a timer if the UE enters an Idle state, and allowing the UE to enter the Deregistered state if the timer expires.

### TECHNICAL FIELD

The present invention relates to a wireless communication system, and more particularly to a method for performing/supporting registration management (and/or connection management) and a device supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

An object of the present invention is to propose a method for managing registration of a User Equipment (UE) depending on whether a mobility level of the UE and/or mobile terminated (MT) service are/is required.

An object of the present invention is to also propose a method for managing detach of a UE depending on whether a mobility level of the UE and/or MT service are/is required.

A UE that does not require the MT service (e.g., UE registered with a network over a non-3GPP (3rd Generation Partnership Project) access, for example, Wireless Local Area Network (WLAN) access) may not perform a Registration Area update procedure and a periodic Registration Area update procedure and may not be paged. In the case of such a UE, there is a problem that it is impossible to confirm whether the corresponding UE has been detached and when the corresponding UE has been detached. Hence, an object of the present invention is to propose a registration management method (e.g., a detach method) for a UE.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

In one aspect of the present invention, a method for managing registration performed by a User Equipment (UE), that cannot be paged by a network and does not perform a periodic registration area update, in a wireless communication system, the method may comprise receiving a timer value for managing a Deregistered state of the UE from the network during a registration procedure, starting a timer when the UE enters an Idle state, and entering the Deregistered state when the timer expires.

In another aspect of the present invention, a User Equipment (UE) for performing a registration management method in a wireless communication system may comprise a communication module configured to transmit and receive a signal, and a processor configured to control the communication module, wherein the processor may be configured to receive a timer value for managing a Deregistered state of the UE from a network during a registration procedure, start a timer when the UE enters an Idle state, and enter the Deregistered state when the timer expires, wherein the UE cannot be paged by the network and may not perform a periodic registration area update.

Preferably, if the UE enters a Connected state from the Idle state, the method may further comprise resetting the timer.

Preferably, if the timer does not expire upon generation of Mobile Originated data, the method may further comprise initiating a service request procedure.

Preferably, if the timer has expired upon generation of Mobile Originated data, the method may further comprise initiating the registration procedure.

Preferably, the UE may be an UE configured with a Limited mobility level at which a service area is limited, or an Unlimited mobility level at which a service area is unlimited.

Preferably, the UE may not perform a registration area update procedure regardless of a mobility level of the UE.

Preferably, if the UE is configured with an Unlimited mobility level, the method may further comprise initiating a service request procedure by transmitting a service request message including identification of a serving core network node.

Preferably, the UE may be a UE that is registered with the network over a non-3GPP (3rd Generation Partnership Project) access.

### Advantageous Effects

Embodiments of the present invention can save resources of a system and a User Equipment (UE) by properly performing registration management of the UE depending on whether a mobility level of the UE and/or mobile terminated (MT) service are/is required.

Embodiments of the present invention can manage detach of a UE that is not paged and does not perform (periodic) Registration Area update, i.e., does not require MT service (e.g., a UE registered with a network over a non-3GPP access, for example, a WLAN access).

It will be appreciated by persons skilled in the art that the effects that can be achieved with the present invention are not limited to what has been particularly described hereinabove and other advantages of the present invention will be more clearly understood from the following detailed description.

### DESCRIPTION OF DRAWINGS

The accompanying drawings, that may be included to provide a further understanding of the disclosure and are incorporated in and constitute a part of this specification, illustrate embodiments of the disclosure and together with the description serve to explain various principles of the disclosure.

FIG. 1 illustrates a 5G (5 Generation) system architecture using reference point representation to which the present invention is applicable.

FIG. 2 illustrates a 5G system architecture to which the present invention is applicable.

FIG. 3 illustrates an NG-RAN architecture to which the present invention is applicable.

FIG. 4 illustrates a wireless protocol stack in a wireless communication system to which the present invention is applicable.

FIG. 5 illustrates a registration management state model in a wireless communication system to which the present invention is applicable.

FIG. 6 illustrates a connection management state model in a wireless communication system to which the present invention is applicable.

FIG. 7 illustrates a 5G core network architecture supporting non-3GPP access to which the present invention is applicable.

FIG. 8 illustrates an attach procedure (or registration procedure) of a UE, with which a limited mobility level is configured, in accordance with an embodiment of the present invention.

FIG. 9 illustrates an attach procedure (or registration procedure) of a UE that does not require MT service in accordance with an embodiment of the present invention.

FIG. 10 illustrates a mobility management method according to an embodiment of the present invention.

FIG. 11 illustrates a CN relocation procedure triggered by a service request in accordance with an embodiment of the present invention.

FIG. 12 illustrates a block diagram of a communication device according to an embodiment of the present invention.

FIG. 13 illustrates a block diagram of a wireless communication device according to an embodiment of the present invention.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention can be embodied without the specific information.

For some cases, to avoid obscuring the technical principles of the present invention, structures and devices well-known to the public can be omitted or can be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE can be performed by the base station or by network nodes other than the base station. The term Base Station (BS) can be replaced with a fixed station, Node B, evolved-NodeB (eNB), Base Transceiver System (BTS), or Access Point (AP). Also, a terminal can be fixed or mobile; and the term can be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter can be part of the base station, and a receiver can be part of the terminal. Similarly, in uplink transmission, a transmitter can be part of the terminal, and a receiver can be part of the base station.

Specific terms used in the following descriptions are introduced to help understanding the present invention, and the specific terms can be used in different ways as long as it does not leave the technical scope of the present invention.

Embodiments of the present invention can be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention can be supported by the documents above. Also, all of the terms disclosed in this document can be explained with reference to the standard documents.

To clarify the descriptions, this document is based on the 3GPP 5G (5 Generation) system, but the technical features of the present invention are not limited to the current descriptions.

Terms used in this document are defined as follows.

Evolved Packet System (EPS): a network system including an Evolved Packet Core (EPC), that is an Internet Protocol (IP) based packet switched core network, and an access network such as LTE and UTRAN. The EPS is a network of an evolved version of a Universal Mobile Telecommunications System (UMTS).

eNodeB: a base station of an EPS network. The eNodeB is installed outdoor, and its coverage has a scale of a macro cell.

International Mobile Subscriber Identity (IMSI): an internationally unique subscriber identity allocated in a mobile communication network.

Public Land Mobile Network (PLMN): a network configured for the purpose of providing mobile communication services to individuals. The PLMN can be configured for each operator.

5G system (5GS): a system composed of a 5G Access Network (AN), a 5G core network and a User Equipment (UE).

5G Access Network (5G-AN) (or AN): an access network composed of a New Generation Radio Access Network (NG-RAN) and/or a non-3GPP Access Network (AN) connected to the 5G core network.

New Generation Radio Access Network (NG-RAN) (or RAN): a Radio Access Network having a common feature of being connected to 5GC and supporting one or more of the following options:

1) Standalone New Radio.

2) New radio that is an anchor supporting E-UTRA extension.

3) Standalone E-UTRA (for example, eNodeB).

4) Anchor supporting new radio extension

5G Core Network (5GC): a core network connected to a 5G access network.

Network Function (NF): means a processing function adopted in 3GPP within a network or defined in 3GPP. The processing function includes a defined functional behavior and an interface defined in 3GPP.

NF service: a function exposed by the NF via a service-based interface and consumed by other authenticated NF(s).

Network Slice: a logical network that provides specific network capability(s) and network feature(s).

Network Slice instance: a set of NF instance(s) and required resources(s) (e.g., compute, storage, and networking resources) that form a deployed network slice.

Protocol Data Unit (PDU) Connectivity Service: service providing the exchange of PDU(s) between the UE and a data network.

PDU Connectivity Service: service providing the exchange of PDU(s) between the UE and a data network.

PDU Session: association between the UE and the data network providing the PDU Connectivity Service. An association type may be Internet Protocol (IP), Ethernet, or unstructured.

Non-Access Stratum (NAS): a functional layer for transceiving signaling and a traffic message between the UE and the core network in EPS and 5GS protocol stack. The NAS mainly functions to support mobility of the UE and support a session management procedure.

5G System Architecture to Which the Present Invention is Applicable

A 5G system is an advanced technology from 4G LTE mobile communication technology and supports a new Radio Access Technology (RAT), extended Long Term Evolution (eLTE) as an extended technology of LTE, non-3GPP access (e.g., Wireless Local Area Network (WLAN) access), etc. through the evolution of an existing mobile communication network structure or a Clean-state structure.

he 5G system is defined based on a service, and an interaction between Network Functions (NFs) in an architecture for the 5G system can be represented in two ways as follows.

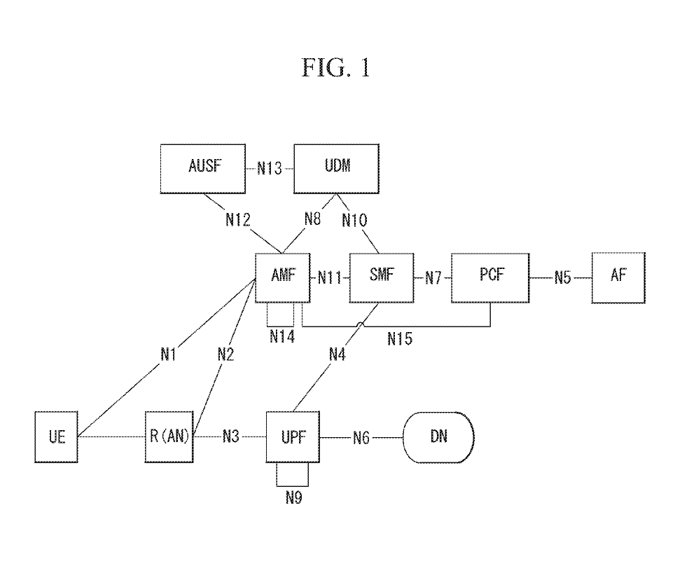

Reference point representation (see FIG. 1): indicates an interaction between NF services in NFs described by a point-to-point reference point (e.g., N11) between two NFs (e.g. AMF and SMF).

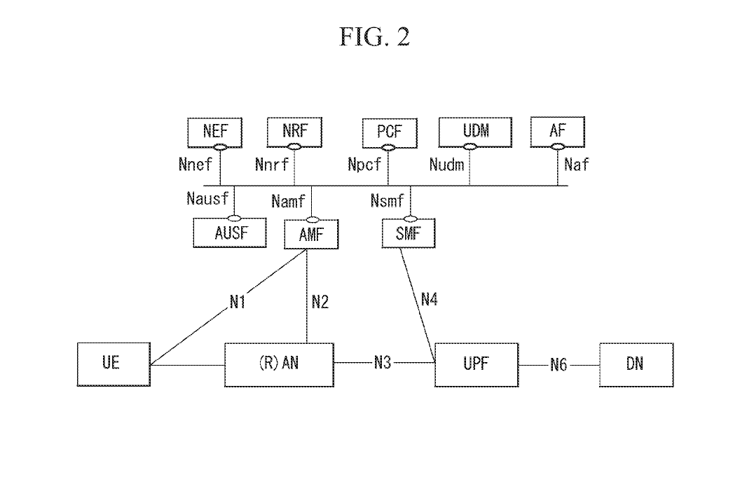

Service-based representation (see FIG. 2): network functions (e.g., AMF) within a Control Plane (CP) allow other authenticated network functions to access its services. The representation also includes a point-to-point reference point, if necessary.

FIG. 1 illustrates a 5G system architecture using reference point representation to which the present invention is applicable.

Referring to FIG. 1, a 5G system architecture may include various components (i.e., network functions (NFs)). FIG. 1 illustrates some of the various components including an Authentication Server Function (AUSF), a (Core) Access and Mobility Management Function (AMF), a Session Management Function (SMF), a Policy Control function (PCF), an Application Function (AF), a Unified Data Management (UDM), Data network (DN), User plane Function (UPF), a (Radio) Access Network ((R)AN), and a User Equipment (UE).

Respective NFs support the following functions.

The AUSF stores data for the authentication of the UE.

The AMF provides a function for the connection and mobility management for each UE, and one AMF can be basically connected to one UE.

More specifically, the AMF supports functions of inter-CN node signaling for mobility between 3GPP access networks, termination of RAN CP interface (i.e., N2 interface), termination N1 of NAS signaling, NAS signaling security (NAS ciphering and integrity protection), AS security control, registration management (registration area management), connection management, idle mode UE reachability (including control and execution of paging retransmission), mobility management control (subscription and policy), support of intra-system mobility and inter-system mobility, support of network slicing, SMF selection, lawful intercept (for an interface to AMF event and L1 system), providing the delivery of a session management (SM) message between UE and SMF, transparent proxy for routing the SM message, access authentication, access authorization including roaming authority check, providing the delivery of a SMS message between UE and SMSF, Security Anchor Function (SEA), Security Context Management (SCM), and the like.

Some or all of the functions of the AMF can be supported in a single instance of one AMF.

The DN means, for example, operator services, internet access, or 3rd party service. The DN transmits a downlink Protocol Data Unit (PDU) to the UPF or receives the PDU transmitted from the UE from the UPF.

The PCF receives information about packet flow from an application server and provides functions of determining policies such as mobility management and session management. More specifically, the PCF supports functions of supporting a unified policy framework for controlling a network operation, providing a policy rule so that CP function(s) (e.g., AMF, SMF, etc.) can enforce the policy rule, and implementing a front end for accessing related subscription information for policy decision in a User Data Repository (UDR).

The SMF provides a session management function. If the UE has a plurality of sessions, the sessions can be respectively managed by different SMFs.

More specifically, the SMF supports functions of session management (e.g., session establishment, modification, and release, including tunnel maintenance between the UPF and the AN node), UE IP address allocation and management (including optional authentication), selection and control of UP function, configuring traffic steering at UPF to route traffic to proper destination, termination of interfaces toward policy control functions, enforcement of control part of a policy and QoS, lawful intercept (for an interface to SM event and L1 system), termination of SM part of a NAS message, downlink data notification, an initiator of AN specific SM information (sent to AN via the AMF over N2), SSC mode decision of the session, a roaming function, and the like.

Some or all of the functions of the SMF can be supported in a single instance of one SMF.

The UDM stores subscription data of user, policy data, etc. The UDM includes two parts, i.e., application front end (FE) and User Data Repository (UDR).

The FE includes UDM FE taking charge of location management, subscription management, processing of credential, etc. and PCF taking charge of policy control. The UDR stores data required for functions provided by the UDM-FE and a policy profile required by the PCF. Data stored in the UDR includes user subscription data including subscription identifier, security credential, access and mobility related subscription data, and session related subscription data and policy data. The UDM-FE accesses subscription information stored in the UDR and supports functions of Authentication Credential Processing, User Identification Handling, access authentication, registration/mobility management, subscription management, SMS management, and the like.

The UPF transmits the downlink PDU received from the DN to the UE via the (R)AN and transmits the uplink PDU received from the UE to the DN via the (R)AN.

More specifically, the UPF supports functions of anchor point for intra/inter RAT mobility, external PDU session point of interconnect to Data Network (DN), packet routing and forwarding, packet inspection and user plane part of policy rule enforcement, lawful intercept, reporting of traffic usage, uplink classifier to support routing traffic flow to Data Network (DN), branching point to support multi-homed PDU session, QoS handling (e.g., packet filtering, gating, uplink/downlink rate enforcement) for user plane, uplink traffic verification (SDF mapping between Service Data Flow (SDF) and QoS flow), transport level packet marking in the uplink and downlink, downlink packet buffering and downlink data notification triggering, and the like. Some or all of the functions of the UPF can be supported in a single instance of one UPF.

AF interacts with 3GPP core network to provide services (e.g., support functions of an application influence on traffic routing, network capability exposure access, interaction with policy framework for policy control, and the like).

(R)AN collectively refers to a new radio access network supporting both evolved E-UTRA, that is an evolved version of 4G radio access technology, and a New Radio (NR) access technology (e.g., gNB).

gNB supports functions of radio resource management function (i.e., radio bearer control, radio admission control, connection mobility control, dynamic allocation of resources to the UE in uplink/downlink (scheduling)), Internet Protocol (IP) header compression, encryption of user data stream and integrity protection, selection of AMF upon attachment of the UE if routing to the AMF is not determined from information provided to the UE, routing of user plane data to UPF(s), routing of control plane information to ANF, connection setup and release, scheduling and transmission of a paging message (generated from the AMF), scheduling and transmission of system broadcast information (generated from the AMF or operating and maintenance (O&M)), measurement and measurement reporting configuration for mobility and scheduling, transport level packet marking in uplink, session management, support of network slicing, QoS flow management and mapping to data radio bearer, support of a UE in an inactive mode, NAS message distribution function, NAS node selection function, radio access network sharing, dual connectivity, tight interworking between NR and E-UTRA, and the like.

The UE means a user equipment. The user equipment may be referred to as a term such as a terminal, a mobile equipment (ME), and a mobile station (MS). The user equipment may be a portable device such as a notebook computer, a cellular phone, a personal digital assistant (PDA), a smart phone, and a multimedia device, or a non-portable device such as a personal computer (PC) and a vehicle-mounted device.

Although Unstructured Data Storage network Function (UDSF), Structured Data Storage network Function (SDSF), Network Exposure Function (NEF), and NF Repository Function (NRF) are not shown in FIG. 1 for clarity of explanation, all the NFs shown in FIG. 1 can perform interaction with the UDSF, the NEF and the NRF, if necessary.

The NEF provides a means to securely expose services and capabilities provided by 3GPP network functions, for example, 3rd party, internal exposure/re-exposure, application function, and edge computing. The NEF receives information from other network function(s) (based on exposed capabilities of other network function(s)). The NEF can store the received information as structured data using a standardized interface to a data storage network function. The stored information can be re-exposed by the NEF to other network functions and other application functions and can be used for other purposes such as analytics.

The NRF supports a service discovery function. The NRF receives NF Discovery Request from NF instance and provides information of the discovered NF instance to the NF instance. The NRF also maintains available NF instances and their supported services.

The SDSF is structured data by any NEF and is a selective function to support a storage and retrieval function of information.

The UDSF is unstructured data by any NF and is a selective function to support a storage and retrieval function of information.

FIG. 1 illustrates a reference model where the UE accesses one DN using one PDU session, for convenience of explanation. However, the present invention is not limited thereto.

The UE can simultaneously access two (i.e., local and central) data networks using multiple PDU sessions. In this instance, two SMFs may be selected for different PDU sessions. Each SMF may have a capability capable of controlling both local UPF and central UPF within the PDU session.

Further, the UE can simultaneously access two (i.e., local and central) data networks provided within a single PDU session.

In the 3GPP system, a conceptual link connecting between the NFs in the 5G system is defined as a reference point. The following illustrates reference points included in the 5G system architecture as represented in FIGS. 1.

N1: Reference point between the UE and the AMF

N2: Reference point between the (R)AN and the AMF

N3: Reference point between the (R)AN and the UPF

N4: Reference point between the SMF and the UPF

N5: Reference point between the PCF and the AF

N6: Reference point between the UPF and the data network

N7: Reference point between the SMF and the PCF

N24: Reference point between the PCF in the visited network and the PCF in the home network

N8: Reference point between the UDM and the AMF

N9: Reference point between two core UPFs

N10: Reference point between the UDM and the SMF

N11: Reference point between the AMF and the SMF

N12: Reference point between the AMF and the AUSF

N13: Reference point between UDM and Authentication Server function (AUSF)

N14: Reference point between two AMFs

N15: Reference point between the PCF and the AMF in case of non-roaming scenario, reference point between the PCF in the visited network and the AMF in case of roaming scenario

N16: Reference point between two SMFs (reference point between the SMF in the visited network and the SMF in the home network in case of roaming scenario)

N17: Reference point between AMF and EIR

N18: Reference point between any NF and UDSF

N19: Reference point between the NEF and the SDSF

FIG. 2 illustrates a 5G system architecture to which the present invention is applicable.

Service-based interfaces illustrated in FIG. 2 indicate a set of services provided/exposed by a predetermined NF. The service-based interfaces are used in control plane. The following illustrates the service-based interfaces included in the 5G system architecture as represented in FIG. 1.

Namf: Service-based interface exhibited by the AMF

Nsmf: Service-based interface exhibited by the SMF

Nnef: Service-based interface exhibited by the NEF

Npcf: Service-based interface exhibited by the PCF

Nudm: Service-based interface exhibited by the UDM

Naf: Service-based interface exhibited by the AF

Nnrf: Service-based interface exhibited by the NRF

Nausf: Service-based interface exhibited by the AUSF

The NF service is one type of capability exposed by an NF (i.e., NF service producer) to other NF (i.e., NF service consumer) via the service-based interface. The NF can expose one or more NF service(s). The following standard is applied to define the NF service.

The NF services are derived from information flow for explaining an end-to-end function.

Complete end-to-end message flow is explained by a sequence of NF service invocation.

Two operations that the NF(s) provide its services via the service-based interface are as follows:

i) “Request-response”: A control plane NF_B (i.e., NF service producer) is requested from another control plane NF_A (i.e., NF service consumer) to provide a certain NF service (including performing an operation and/or providing information). The NF_B responses NF service result based on information provided by the NF_A in the Request.

In order to fulfil the request, the NF_B may in turn consume NF services from other NF(s). In Request-response mechanism, communication is performed one to one between two NFs (i.e., consumer and producer).

ii) “Subscribe-Notify”

A control plane NF_A (i.e., NF service consumer) subscribes to a NF service provided by another control plane NF_B (i.e., NF service producer). Multiple control plane NFs may subscribe to the same control plane NF service. The NF_B notifies a result of this NF service to the interested NFs that are subscribed to this NF service. A subscription request from the consumer may include a notification request for periodic update or notification triggered through specific events (e.g., change of requested information, reaching a certain critical value, etc.). This mechanism also includes the case where the NF(s) (e.g., NF_B) implicitly subscribes to a specific notice without an explicit subscription request (e.g., the case where the NF(s) subscribes through a successful registration procedure).

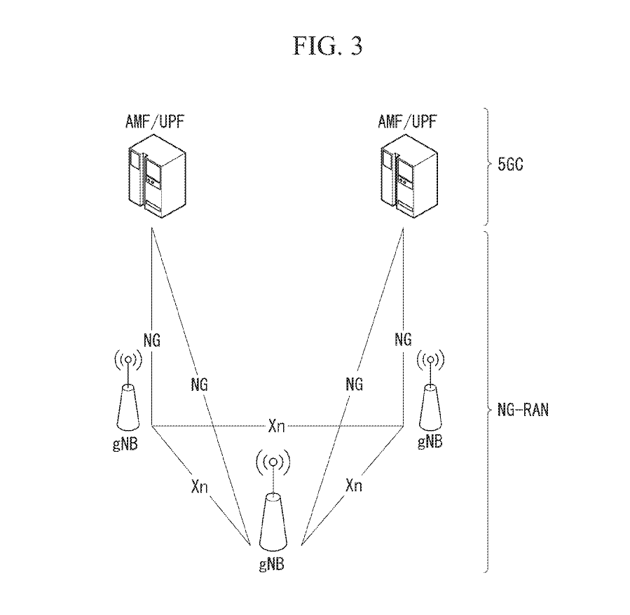

FIG. 3 illustrates an NG-RAN architecture to which the present invention is applicable.

Referring to FIG. 3, a New Generation Radio Access Network (NG-RAN) includes gNB (NR NodeB)(s) and/or eNB (eNodeB)(s) providing a user plane toward a UE and termination of control plane protocol.

The gNB(s) are interconnected using an Xn interface, and the eNB(s) connected to the gNB(s) and 5GC are also interconnected using the Xn interface. The gNB(s) and the eNB(s) are connected to the 5GC using an NG interface. More specifically, the gNB(s) and the eNB(s) are connected to the AMF using an NG-C interface (i.e., N2 reference point) that is a control plane interface between the NG-RAN the 5GC, and are connected to the UPF using an NG-U interface (i.e., N3 reference point) that is a user plane interface between the NG-RAN and the 5GC.

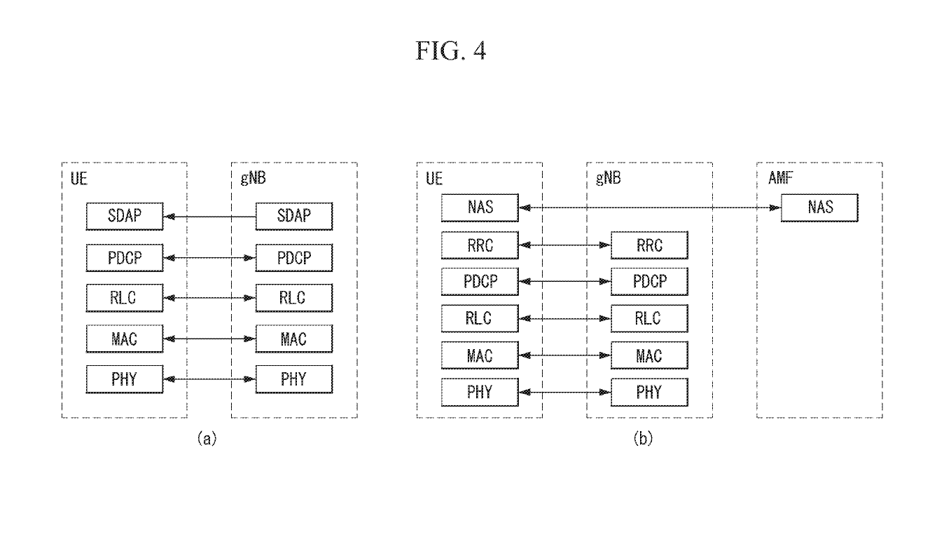

FIG. 4 illustrates a wireless protocol stack in a wireless communication system to which the present invention is applicable.

FIG. 4(a) illustrates a radio interface user plane protocol stack between a UE and gNB, and FIG. 4(b) illustrates a radio interface control plane protocol stack between the UE and the gNB.

The control plane means a path through which control messages used for a UE and a network to manage calls are transmitted. The user plane means a path through which data generated in an application layer, for example, voice data, Internet packet data, and so on are transmitted.

Referring to FIG. 4(a), the user plane protocol stack may be divided into Layer 1 (i.e., physical (PHY) layer) and Layer 2.

Referring to FIG. 4(b), the control plane protocol stack may be divided into Layer 1 (i.e., PHY layer), Layer 2, Layer 3 (i.e., radio resource control (RRC) layer), and a Non-Access Stratum (NAS) layer.

The Layer 2 is divided into a Medium Access Control (MAC) sublayer, a Radio Link Control (RLC) sublayer, a Packet Data Convergence Protocol (PDC) sublayer, and a Service Data Adaptation Protocol (SDAP) sublayer (in case of the user plane).

A radio bearer is classified into two groups: data radio bearer (DRB) for user plane data and signaling radio bearer (SRB) for control plane data.

Each layer of the control plane and the user plane of the radio protocol is described below.

1) The Layer 1, i.e., the PHY layer, provides information transfer service to an upper layer by using a physical channel The PHY layer is connected to the MAC sublayer located at an upper level through a transport channel, and data are transmitted between the MAC sublayer and the PHY layer through the transport channel. The transport channel is classified according to how and which feature data is transmitted via a radio interface. And, data is transmitted between different PHY layers, between a PHY layer of a transmitter and a PHY layer of a receiver, through a physical channel.

2) The MAC sublayer performs mapping between a logical channel and a transport channel; multiplexing/demultiplexing of MAC Service Data Unit (SDU) belonging to one or different logical channel(s) to/from a transport block (TB) delivered to/from the PHY layer through a transport channel; scheduling information reporting; error correction through hybrid automatic repeat request (HARQ); priority handling between UEs using dynamic scheduling; priority handling between logical channels of one UE using logical channel priority; and padding.

Different kinds of data deliver a service provided by the MAC sublayer. Each logical channel type defines what type of information is delivered.

The logical channel is classified into two groups: a Control Channel and a Traffic Channel.

i) The Control Channel is used to deliver only control plane information and is as follows.

Broadcast Control Channel (BCCH): a downlink channel for broadcasting system control information.

Paging Control Channel (PCCH): a downlink channel that delivers paging information and system information change notification.

Common Control Channel (CCCH): a channel for transmitting control information between a UE and a network. This channel is used for UEs having no RRC connection with the network.

Dedicated Control Channel (DCCH): a point-to-point bi-directional channel for transmitting dedicated control information between the UE and the network. This channel is used by the UE having an RRC connection.

ii) The Traffic Channel is used to use only user plane information.

Dedicated Traffic Channel (DTCH): a point-to-point channel, dedicated to a single UE, for delivering user information. The DTCH may exist in both uplink and downlink.

In the downlink, connection between the logical channel and the transport channel is as follows.

The BCCH may be mapped to BCH. The BCCH may be mapped to DL-SCH. The PCCH may be mapped to PCH. The CCCH may be mapped to the DL-SCH. The DCCH may be mapped to the DL-SCH. The DTCH may be mapped to the DL-SCH.

In the uplink, connection between the logical channel and the transport channel is as follows. The CCCH may be mapped to UL-SCH. The DCCH may be mapped to the UL-SCH. The DTCH may be mapped to the UL-SCH.

3) The RLC sublayer supports three transmission modes: a Transparent Mode (TM), an Unacknowledged Mode (UM), and an Acknowledged Mode (AM).

The RLC configuration may be applied for each logical channel In case of SRB, the TM or the AM is used. On the other hand, in case of DRB, the UM the AM is used.

The RLC sublayer performs the delivery of the upper layer PDU; sequence numbering independent of PDCP; error correction through automatic repeat request (ARQ); segmentation and re-segmentation; reassembly of SDU; RLC SDU discard; and RLC re-establishment.

4) A PDCP sublayer for the user plane performs Sequence Numbering; header compression and decompression (Robust Header Compression (RoHC) only); delivery of user data; reordering and duplicate detection (if the delivery to a layer above the PDCP is required); PDCP PDU routing (in case of a split bearer); re-transmission of PDCP SDU; ciphering and deciphering; PDCP SDU discard; PDCP re-establishment and data recovery for RLC AM; and duplication of PDCP PDU.

The PDCP sublayer for the control plane additionally performs Sequence Numbering; ciphering, deciphering and integrity protection; delivery of control plane data; duplicate detection; and duplication of PDCP PDU.

When duplication is configured for a radio bearer by RRC, an additional RLC entity and an additional logical channel are added to the radio bearer to control the duplicated PDCP PDU(s). The duplication at PDCP includes transmitting the same PDCP PDUs twice. Once it is transmitted to the original RLC entity, and a second time it is transmitted to the additional RLC entity. In this instance, the original PDCP PDU and the corresponding duplicate are not transmitted to the same transport block. Two different logical channels may belong to the same MAC entity (in case of CA) or different MAC entities (in case of DC). In the former case, logical channel mapping restriction is used to ensure that the original PDCP PDU and the corresponding duplicate are not transmitted to the same transport block.

5) The SDAP sublayer performs i) mapping between QoS flow and data radio bearer, and ii) QoS flow identification (ID) marking in downlink and uplink packet.

single protocol entity of SDAP is configured for each individual PDU session, but exceptionally, in case of dual Connectivity (DC), two SDAP entities can be configured.

6) A RRC sublayer performs broadcast of system information related to Access Stratum (AS) and Non-Access Stratum (NAS); paging initiated by 5GC or NG-RAN; establishment, maintenance and release of RRC connection between UE and NG-RAN (additionally including modification and release of carrier aggregation and also additionally including modification and release of Dual Connectivity between E-UTRAN and NR or in NR); security function including key management; establishment, configuration, maintenance and release of SRB(s) and DRB(s); delivery of handover and context; UE cell selection and re-release and control of cell selection/reselection: mobility function including inter-RAT mobility; QoS management function, UE measurement reporting and control of reporting; detection of radio link failure and recovery from radio link failure; and NAS message delivery from NAS to UE and NAS message delivery from UE to NAS.

Mobility Management

Registration Management (RM) is used to register or de-register the UE/user to the network and establish user context in the network.

1) Registration Management

The UE/user needs to register with the network to receive service that requires registration. After the registration is performed once, if applicable, the UE can update its registration to the network to periodically maintain the reachability (i.e., periodic registration update), or update its capability or re-negotiate protocol parameters upon movement (mobility registration update).

An Initial Registration procedure includes execution of a Network Access Control function (i.e., user authentication and access authentication based on a subscription profile in the UDM). As a result of the registration procedure, identification of serving AMF is registered in the UDM.

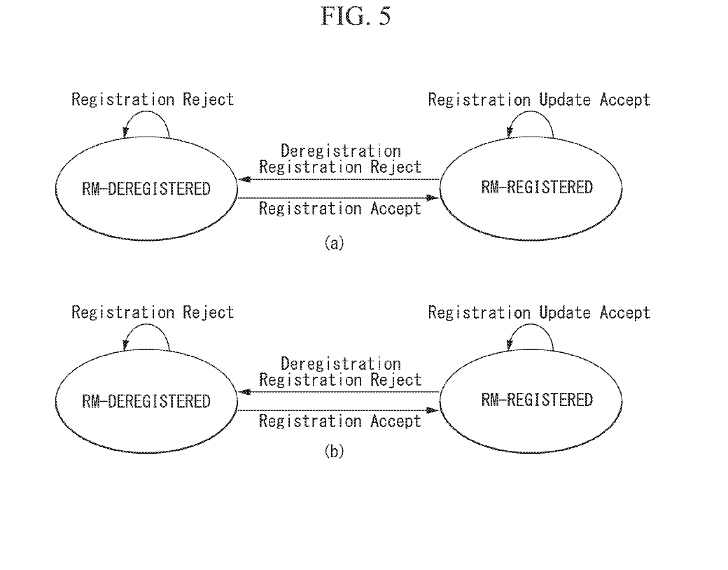

FIG. 5 illustrates a registration management state model in a wireless communication system to which the present invention is applicable.

Referring to FIG. 5, two RM states of RM-DEREGISTERED and RM-REGISTERED are used in the UE and the AMF to reflect a registration state of the UE in selected PLMN. FIG. 5(a) illustrates an RM state model in the UE, and FIG. 5(b) illustrates an RM state model in the AMF.

In the RM-DEREGISTERED state, the UE is not registered with the network. The UE context in the AMF does not maintain a valid location or routing information for the UE, and thus the UE is not reachable by the AMF. However, for example, some UE context may be still stored in the UE and the AMF to prevent an authentication procedure from being performed during every registration procedure.

In the RM-DEREGISTERED state, if the UE needs to receive service that requires registration, the UE attempts to register with the selected PLMN using the Initial Registration procedure. Or, if the UE receives Registration Reject at Initial Registration, the UE remains in the RM-DEREGISTERED state. On the other hand, the UE enters the RM-REGISTERED state when receiving Registration Accept.

In the RM-DEREGISTERED state, when applicable, the AMF accepts the Initial Registration of the UE by sending Registration Accept to the UE and enters the RM-REGISTERED state. Or, when applicable, the AMF rejects the Initial Registration of the UE by sending Registration Reject to the UE.

In the RM-REGISTERED state, the UE is registered with the network. In the RM-REGISTERED state, the UE can receive service that requires registration with the network.

In the RM-REGISTERED state, if there is no Tracking Area Identity (TAI) of a current serving cell on a list of the TAI that the UE has received from the network, the UE performs a Mobility Registration Update procedure in order to maintain the registration of the UE and enable the AMF to page the UE. Or, the UE performs a Periodic Registration Update procedure triggered by the expiration of a periodic update timer in order to notify the network that the UE is still in an active state. Or, the UE performs a Registration Update procedure in order to update its capability information or re-negotiate the network with protocol parameters. Or, when the UE needs to be no longer registered with the PLMN, the UE performs a Deregistration procedure and enters the RM-DEREGISTERED state. The UE can decide to deregister from the network at any time. Or, when the UE receives a Registration Reject message or a Deregistration message or when the UE performs a Local Deregistration procedure without the initiation of any signaling, the UE enters the RM-DEREGISTERED state.

In the RM-REGISTERED state, when the UE needs to be no longer registered with the PLMN, the AMF performs a Deregistration procedure and enters the RM-DEREGISTERED state. The AMF can decide to deregister the UE at any time. Or, after an Implicit Deregistration timer expires, the AMF performs Implicit Deregistration at any time. The AMF enters the RM-DEREGISTERED state after the Implicit Deregistration. Or, the AMF performs Local Deregistration for the UE that have negotiated to perform deregistration at an end of communication. The AMF enters the RM-DEREGISTERED state after the Local Deregistration. Or, when applicable, the AMF accepts or rejects Registration Update from the UE. When the AMF rejects the Registration Update from the UE, the AMF may reject the UE registration.

Registration area management includes functions of allocating and re-allocating a registration area to the UE. The registration area is managed for each access type (i.e., 3GPP access or non-3GPP access).

When the UE is registered with the network over the 3GPP access, the AMF allocates a set of Tracking Area(s) (TAs) in a TAI list to the UE. When the AMF allocates the registration area (i.e., the set of the TA in the TAI list), the AMF may consider various information (for example, mobility pattern, allowed/non-allowed area, etc.). The AMF having whole PLMN (all PLMN) as a serving area may allocate the whole PLMN as the registration area to the UE that is in a MICO mode.

The 5G system supports allocation of a TAI list including different 5G-RAT(s) in a single TAI list.

When the UE is registered with the network over the non-3GPP access, the registration area for the non-3GPP access corresponds to a unique reserved TAI value (i.e., dedicated to the non-3GPP access). Thus, there is a unique TA for the non-3GPP access to SGC, and this is called N3GPP TAI.

The AMF includes only TAI(s) applicable to an access, to which the TAI list is transmitted, when producing the TAI list.

2) Connection Management

Connection Management (CM) is used to establish and release signaling connection between the UE and the AMF. The CM includes functions of establishing and releasing signaling connection between the UE and the AMF over N1. The signaling connection is used to enable NAS signaling exchange between the UE and a core network. The signaling connection includes both AN signaling connection for the UE between the UE and the AN and N2 connection for the UE between the AN and the AMF.

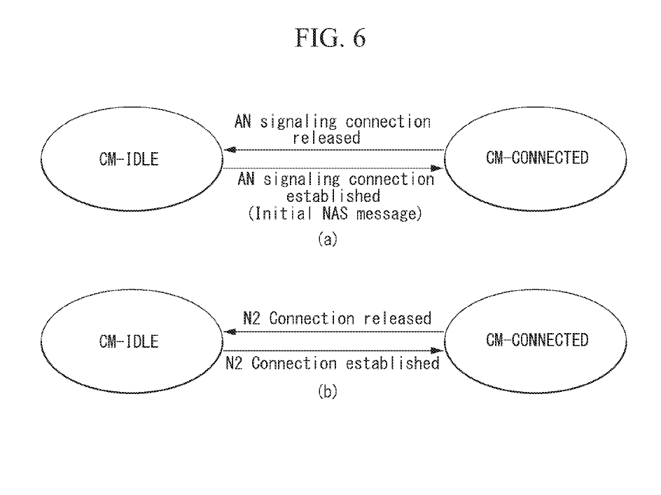

FIG. 6 illustrates a connection management state model in a wireless communication system to which the present invention is applicable.

Referring to FIG. 6, two CM states of CM-IDLE and CM-CONNECTED are used to reflect NAS signaling connection of the UE with the AMF. FIG. 6(a) illustrates CM state transition in the UE, and FIG. 6(b) illustrates CM state transition in the AMF.

The UE in the CM-IDLE state is in the RM-REGISTERED state and does not have the NAS signaling connection established with the AMF over N1. The UE performs cell selection, cell re-selection, and PLMN selection.

There are no AN signaling connection, N2 connection and N3 connection for the UE in the CM-IDLE state.

In the CM-IDLE state, if the UE is not in the MICO mode, the UE responds to paging (upon the reception) by performing a service request procedure. Or, when the UE has uplink signaling or user data to be transmitted, the UE performs the service request procedure. Or, the UE enter the CM-CONNECTED state whenever the AN signaling connection is established between the UE and the AN. Or, the transmission of an Initial NAS message (Registration Request, Service Request, or Deregistration Request) initiates the transition from the CM-IDLE state to the CM-CONNECTED state. In the CM-IDLE state, when the AMF has signaling or mobile-terminated data to be transmitted to the UE if the UE is not in the MICO mode, the AMF performs a network triggered service request procedure by transmitting Paging Request to the corresponding UE. The AMF enter the CM-CONNECTED state whenever the N2 connection is established for the corresponding UE between the AN and the AMF.

The UE in the CM-CONNECTED state has the NAS signaling connection with the AMF over N1.

In the CM-CONNECTED state, the UE enters the CM-IDLE state whenever the AN signaling connection is released.

In the CM-CONNECTED state, the AMF enters the CM-IDLE state whenever N2 signaling connection and N3 signaling connection for the UE are released.

When a NAS signaling procedure is completed, the AMF may decide to release the NAS signaling connection of the UE. When the NAS signaling connection release is completed, the CM state in the UE is changed to the CM-IDLE state. When a N2 context release procedure is completed, the CM state for the UE in the AMF is changed to the CM-IDLE state.

The AMF can keep the UE in the CM-CONNECTED state until the UE de-registers from the core network.

The UE in the CM-CONNECTED state may be in a RRC Inactive state. When the UE is in the RRC Inactive state, UE reachability is managed by RAN using assistance information from the core network. When the UE is in the RRC Inactive state, UE paging is managed by the RAN. When the UE is in the RRC Inactive state, the UE monitors the paging using UE's CN and RAN identifier.

The RRC Inactive state is applied to the NG-RAN (i.e., applied to NR and E-UTRA connected to 5G CN).

The AMF, based on network configuration, provides assistance information to the NG-RAN to assist the NG-RAN' s decision about whether the UE transitions to the RRC Inactive state.

The RRC Inactive assistance information includes a UE specific DRX value for RAN paging in the RRC Inactive state and a registration area provided to the UE.

CN assistance information is provided to a serving NG RAN node during N2 activation (i.e., during registration, service request, and path switching).

The states of the N2 and N3 reference points are not changed by the UE that enters the CM-CONNECTED state with RRC Inactive. The UE in the RRC Inactive state is aware of a RAN notification area.

When the UE is in the CM-CONNECTED state with the RRC Inactive, the UE can resume RRC connection due to uplink data pending, a mobile initiated signalling procedure (i.e., periodic registration update), a response to RAN paging, or notifying the network that the UE has left the RAN notification area.

If the UE resumes the connection at different NG-RAN nodes within the same PLMN, the UE AS context is retrieved from an old NG-RAN node and a procedure is triggered toward the CN.

When the UE is in the CM-CONNECTED state with the RRC Inactive, the UE performs cell selection to GERAN/UTRAN/EPS and follows an idle mode procedure.

The UE in the CM-CONNECTED state with the RRC Inactive enters a CM-IDLE mode and follows the NAS procedure associated with the following cases.

If a RRC resume procedure fails,

If a movement of the UE to the CM-IDLE mode is required in a fail scenario that cannot be solved in the RRC Inactive mode.

The NAS signaling connection management includes functions of establishing and releasing the NAS signaling connection.

The NAS signaling connection establishment function is provided by the UE and the AMF to establish the NAS signaling connection of the UE in the CM-IDLE state.

When the UE in the CM-IDLE state needs to send the NAS message, the UE initiates a Service Request or a Registration procedure to establish signaling connection to the AMF.

Based on UE preference, UE subscription information, UE mobility pattern, and network configuration, the AMF can keep the NAS signaling connection until the UE de-registers from the network.

A procedure of the release of the NAS signaling connection is initiated by 5G (R)AN node or the AMF.

If the UE detects that the AN signaling connection is released, the UE decides that the NAS signaling connection has been released. If the AMF detects that the N2 context has been released, the AMF decides that the NAS signaling connection has been released.

3) UE Mobility Restriction

Mobility restriction restricts the service access or mobility control of the UE in the 5G system. A mobility restriction function is provided by the UE, the RAN, and the core network.

The mobility restriction is applied to only the 3GPP access and is not applied to the non-3GPP access.

The mobility restriction in the CM-IDLE state and the CM-CONNECTED state with the RRC Inactive is performed by the UE based on information received from the core network. The mobility restriction in the CM-CONNECTED state is performed by the RAN and the core network.

In the CM-CONNECTED state, the core network provides a Handover Restriction List for the mobility restriction to the RAN.

The mobility restriction includes RAT restriction, a Forbidden area, and service area restriction as follow:

RAT restriction: RAT restriction is defined as 3GPP RAT(s) to which the access of the UE is not allowed. The UE in the restricted RAT is not allowed to initiate any communication with the network based on subscription information.

Forbidden area: in a forbidden area under predetermined RAT, the UE is not allowed to initiate any communication with the network based on subscription information.

Service area restriction: the UE defines an area that can initiate or cannot initiate communication with the network as follows:

Allowed area: in an allowed area under predetermined RAT, the UE is allowed to initiate communication with the network if allowable by subscription information.

Non-allowed area: in a non-allowed area under predetermined RAT, the service area of the UE is restricted based on subscription information. The UE and the network are not allowed to initiate session management signaling (in both the CM-IDLE state and the CM-CONNECTED state) acquiring Service Request or user services. The RM procedure of the UE is the same as that in the allowed area. The UE in the non-allowed area responds to the paging of the core network with Service Request.

In a predetermined UE, the core network determines the service area restriction based on UE subscription information. Optionally, the allowed area may be fine-tuned by the PCF (based on, for example, UE location, Permanent Equipment Identifier (PEI), network policies, etc.). The service area restriction may be changed due to, for example, changes in the subscription information, the location, the PEI and/or the polices. The service area restriction can be updated during the Registration procedure.

If the UE has the RAT restriction, the Forbidden area, the allowed area, the non-allowed area, or an overlap area in a combination thereof, the UE proceeds according to the following priority:

An evaluation of the RAT restriction takes precedence over an evaluation of any other mobility restriction;

An evaluation of the Forbidden area takes precedence over an evaluation of the allowed area and the non-allowed area; and

An evaluation of the non-allowed area takes precedence over an evaluation of the allowed area.

4) Mobile Initiated Connection Only (MICO) mode

The UE may indicate a preference of the MICO mode during initial registration or registration update. The AMF determines whether the MICO mode is allowed to the UE based on Local configuration, the preference indicated by the UE, the UE subscription information, the network policies, or a combination thereof, and notifies it to the UE during the Registration procedure.

The UE and the core network re-initiate or exit the MICO mode in the following registration signaling. If the MICO mode is not explicitly indicated in the Registration procedure and the Registration procedure is successfully completed, the UE and the AMF do not use the MICO mode. Namely, the UE operates as a general UE, and the network also treats the corresponding UE as a general UE.

The AMF allocates the registration area to the UE during the Registration procedure. When the AMF indicates the MICO mode to the UE, the registration area is not limited to a size of a paging area. If the AMF serving area is the whole PLMN, the AMF may provide the UE with the “whole PLMN” registration area. In this case, re-registration to the same PLMN due to the mobility does not apply. If the mobility restriction is applied to the UE in the MICO mode, the AMF allocates the allowed area/non-allowed area to the UE.

If the AMF indicates the MICO mode to the UE, the AMF regards the UE as being always unreachable while the UE is in the CM-IDLE state. The AMF rejects any request for downlink data transfer to the corresponding UE that is in the MICO mode and in the CM-IDLE state. The AMF also defers downlink transport such as SMS and location services over NAS. The UE in the MICO mode is reachable for mobile terminated data or signaling only when the UE is in the CM-CONNECTED mode.

When the UE in the MICO mode transitions to the CM-CONNECTED mode, the AMF can provide Pending Data indication to the RAN node to be able to immediately transfer mobile terminated data and/or signaling. If the RAN node receives this indication, the RAN node considers this information when determining user inactivity.

The UE in the MICO mode does not need to listen to paging while the UE is in the CM-IDLE state. The UE in the MICO mode can stop any AS procedure in the CM-IDLE state due to one of the following reasons until the UE initiates the transition from the CM-IDLE mode to the CM-CONNECTED mode:

if change in the UE (e.g. change in configuration) requires an update of the registration with the network

if a periodic registration timer expires

if MO data pending

if MO signaling pending

Non-3GPP Access

The 5G core network supports the connection of the UE over non-3GPP access network (e.g., WLAN).

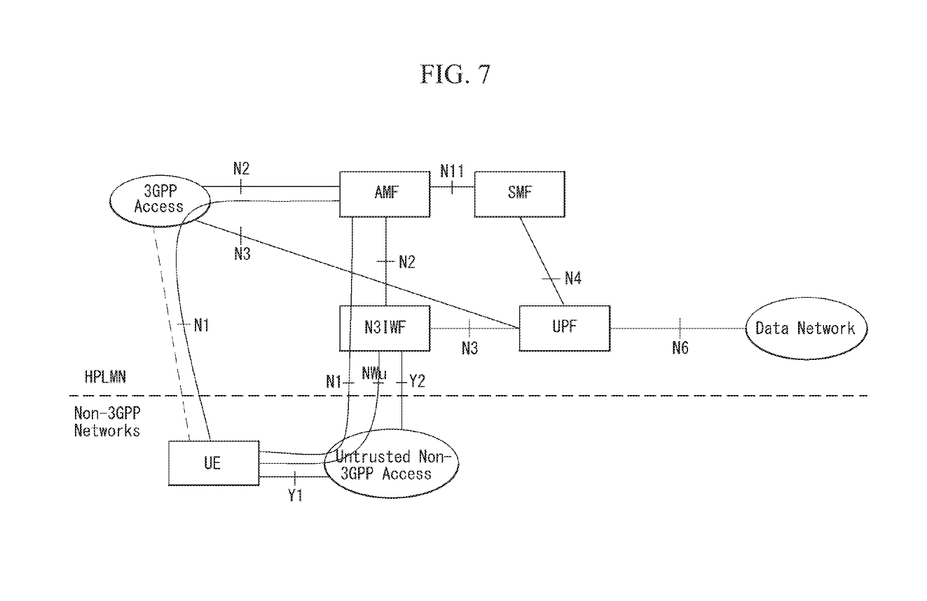

FIG. 7 illustrates a 5G core network architecture supporting non-3GPP access to which the present invention is applicable.

The N2 and N3 reference points are used to connect standalone non-3GPP access to 5G core network control plane functions and user plane functions, respectively.

The UE, that accesses the 5G core network via the standalone non-3GPP access, supports NAS signaling with the 5G core network control plane functions using the N1 reference point after UE attachment.

When the UE is connected via NG-RAN and via the standalone non-3GPP access, multiple N1 instances exist for the UE (i.e., there are one N1 instance via the NG-RAN and one N1 instance via the non-3GPP access).

If selected Non-3GPP InterWorking Function (N3IWF) is located in the same PLMN as the 3GPP access, the UE simultaneously connected to the same 5G core network of PLMN via the 3GPP access and the non-3GPP access is served by a single AMF.

When the UE is connected to the 3GPP access of the PLMN, if the UE selects the N3IWF and the N3IWF is located in a PLMN different from the PLMN of the 3GPP access, the UE is separately served by the two PLMNs. The UE is registered with two separate AMFs. The PDU session over the 3GPP access is served by a SMF different from the SMF serving the PDU session over the non-3GPP access.

The PLMN selection for the 3GPP does not depend on the N3IWF selection. If the UE is registered over the non-3GPP, the UE performs the PLMN selection for the 3GPP access independently of the PLMN to which the N3IWF belongs.

The non-3GPP access network is connected to the 5G Core Network via the N3IWF. The N3IWF is connected to 5G Core Network control plane and user plane via an N2 interface and an N3 interface, respectively.

The UE establishes a N3IWF IP Security (IPSec) tunnel and attaches to the 5G Core Network over untrusted non-3GPP access. The UE is authenticated by the 5G Core Network and is attached to the 5G Core Network during an IPSec tunnel establishment procedure.

After all the PDU sessions for the UE over the non-3GPP access have been released or handed over to the 3GPP access, the UE signaling connection with the AMF can be maintained.

N1 NAS signaling over the standalone non-3GPP access is protected with the same security mechanism applied to N1 over the 3GPP access.

In case of the untrusted non-3GPP access, functions of N3IWF are as follows:

i) IPSec tunnel establishment support with the UE: the N3IWF terminates the UE and IKEv2/IPsec protocol over NWu, authenticates the UE, and relays information required to authenticate an access for the 5G core network over N2.

ii) Termination of N2 and N3 interfaces to the 5G core network for each of control plane and user plane

iii) uplink and downlink control plane NAS signaling (N1) relay between UE and AMF

iv) N2 signaling control from the SMF (relayed by the AMF) associated with PDU session and QoS

v) Establishment of IPsec Security Association (IPsec SA) for supporting PDU session traffic

vi) Relay of uplink and downlink user plane packet between the UE and the UPF. This includes:

De-capsulation/Encapsulation of packet for IPSec and N3 tunneling

QoS enforcement corresponding to N3 packet marking in consideration of QoS requirement related to marking received via N2

N3 user plane marking in uplink

local mobility anchor in the untrusted non-3GPP access network

AMF selection support

Reference points for non-3GPP access are as follows.

Y1: Reference point between the UE and the non-3GPP access (e.g., WLAN). This depends on the non-3GPP access technology.

Y2: Reference point between the untrusted non-3GPP access and the N3IWF for NWu traffic transport

NWu: Reference point between the UE and N3IWF for establishing secure tunnel(s) between the UE and the N3IWF so that control plane and user plane data/signal exchanged between the UE and the 5G core network can be securely transferred over the untrusted non-3GPP access.

Registration Management Method

Evolved Packet System (EPS) has been generally designed for UEs that are free of movement constraint (i.e., all of UEs require an unlimited service area) and UEs that are always capable of mobile originated (MO) service and mobile terminated (MT) service.

Hence, the UE has been required to perform a Normal Tracking Area Update (N-TAU) procedure and a Periodic TAU (P-TAU) procedure during an Idle (e.g., ECM-IDLE or CM-IDLE) interval.

The N-TAU corresponds to a procedure for knowing a location of the UE on Tracking Area (TA) granularity for registration area management for paging, etc. of the UE in a Core Network (CN). The P-TAU corresponds to a procedure for determining whether the UE is normally registered with the network.

Namely, the N-TAU is an operation required to, if the UE leaves a registration area promised with MME (i.e., core control plane (CP)) during a TAU procedure, update this to an area in which the UE is located. The P-TAU is used to manage the registration validity of the UE with the TAU that the UE has to perform after the elapse of a predetermined time after entering the Idle mode regardless of whether the location of the UE is changed.

The MME (network core) immediately drives a detach timer if the P-TAU is not performed at time at which it has to be performed, decides that the corresponding UE has been detached if the timer expires, and deletes context of the UE.

More specifically, the P-TAU procedure is used to periodically notify availability of the UE to the network. The procedure is controlled by a timer T3412 in the UE. A value of the timer T3412 is transmitted to the UE in an ATTACH ACCEPT message by the network and may be transmitted in a TRACKING AREA UPDATE ACCEPT message. The UE applies this value to all of tracking areas of a tracking area list designated to the UE until a new value is received.

When the UE is changed from an EMM-CONNECTED mode to an EMM-IDLE mode, the timer T3412 is reset and starts with an initial value. The timer T3412 is stopped when the UE enters the EMM-CONNECTED mode or an EMM-DEREGISTERED state.

The network oversees the P-TAU procedure of the UE using a mobile reachable timer.

If the UE is not attached for emergency bearer services, the mobile reachable timer is set to be longer than the timer T3412.

When the MME releases NAS signaling connection for the UE, the mobile reachable timer is reset and starts with a setting value. When the NAS signaling connection for the UE is established, the mobile reachable timer is stopped.

If the mobile reachable timer expires, the network starts an implicit detach timer. If the implicit detach timer expires before the UE contacts the network, the network implicitly detaches the UE.

Namely, if the UE does not contact the network by performing the P-TAU until the implicit detach timer expires, the network implicitly detaches the UE.

As described above, because an existing wireless communication system (e.g., EPS) was designed so that all the UEs were capable of the MO service and the MT service, all the UEs were defined to consistently perform the N-TAU and P-TAU procedures described above even in the IDLE state.

However, the fact that all the UEs consistently perform the N-TAU and P-TAU procedures may be the waste of network/radio resources. Therefore, in a next generation wireless communication system (e.g., 5G system), a method has been studied to save resources of UEs as well as systems by restricting a proper operation according to mobility levels of various UEs instead of the UEs performing all of operations.

Namely, resource saving strategies are being discussed in connection with mobility levels of different UEs and different traffic patterns (e.g., a case where only the MO service is required, i.e., the MT service is not required).

Hence, the present invention proposes a registration area management method and a detach management method of a UE depending on a mobility level of the UE and whether a mobile terminated (MT) call is supported.

### Embodiment 1) TAU is Defined Separately Into Registration Area Update and Reachability Upate

The present invention proposes a UE mobility level that consists of two levels including “Limited service area” and “Unlimited service area”.

The present invention also proposes a TAU procedure that is divided into a “Registration Area update” procedure and a “Reachability update” (or Periodic Registration Area update) procedure.

Namely, reachability management for the UE in an IDLE state may mean roles of detecting whether the UE is reachable and providing a location (i.e., an access node) of the UE to a network to reach the UE. This can be performed by paging the UE and tracking the location of the UE. The UE location tracking may include UE registration area tracking (i.e., Registration Area update) and UE reachability tracking (i.e., Reachability update or Periodic Registration Area update).

The following Table 1 indicates an example of UE idle mode operation associated with a mobility restriction level and MT capability requirement.

TABLE 1

| Mobility Level | Unlimited Area | | Limited Area | |
|---|---|---|---|---|
| MT required | O | X | O | X |
| Registration area update | Yes | No | No | No |
| Reachability update | Yes | No | Yes | No |

Referring to Table 1, the mobility level of the UE may be roughly defined as a limited mobility level (or limited area) and an unlimited mobility level (or unlimited area). In this instance, “No mobility” may be classified in the same way as the limited area.

The mobility (restriction) level may be determined based on various conditions such as subscription data of the UE, a location of the UE, an application being used by the UE, and current time and date.

The mobility (restriction) level may be stored in subscription information of the UE and adjusted by a policy controller.

If the UE has the unlimited mobility level, the UE can receive services without restriction in its PLMN area. This may be a general type of UE.

On the other hand, the limited mobility level allows a specific UE to receive services only in a specific area and thus can save resources of the UE and the network.

Examples where the limited mobility level is required may be as follows.

Stationary UE

In case of a stationary UE such as a vending machine or a metering machine, because it does not require the mobility support, it does not require a registration update for registration change.

If the service support is required only in a specific region

It corresponds mainly to an enterprise case and may correspond to UEs used in a museum or a corporation, etc. Namely, a UE used for specific services in a museum does not need the service support if it leaves the museum.

Referring again to Table 1, the detailed operation of the UE described in the above Table 1 may be subdivided depending on whether the MT service is required (i.e., whether there is reachability). Namely, a UE that requires the MT service may be classified as a reachable UE, and a UE that does not require the MT service (i.e., that requires MO service only) may be classified as an unreachable UE.

As indicated by Table 1, the present invention proposes defining whether a Registration area update procedure and/or a Reachability update procedure are performed depending on the mobility level of the UE and whether the MT service is required.

Namely, the present invention proposes defining a TAU procedure separately into a Registration area update procedure and a Reachability update procedure instead of a unified TAU procedure, so that only actions required in an existing TAU procedure can be taken depending on the mobility level of the UE and/or whether the MT service is required.

Registration area update procedure: an example of this procedure may be the same as a TAU procedure triggered when the UE detects that it has entered a new TA that is not on a list of Tracking Area Identity(s) (TAI) that the UE has registered with its network.

Reachability update procedure: an example of this procedure may be the same as a periodic TAU procedure triggered when a P-TAU timer has expired.

Thus, if the UE recognizes that it moves to the new TA, the UE can perform the Registration area update procedure. If the reachability update is required after the elapse of a certain time after the UE enters an Idle mode, the UE can perform the Reachability update procedure.

Referring again to Table 1, the UE that does not require the MT service may not perform any TAU procedure (i.e., the Registration area update procedure and the Reachability update procedure) and may not perform a paging procedure, in order to maximize resource efficiency of both the UE and the network.

In other words, the UE that does not require the MT service corresponds to the case where only the MO service is supported or terminated service (i.e., the MT service) is supported only when the UE is in the connected mode. In case of such a UE, the paging generally required for the MT service may not be necessary.

In addition, the UE may not need paging monitoring through the N-TAU (i.e., Registration Area update) performance and Discontinuous Reception (DRX) application performed when the TA to which the UE belongs is changed to manage a paging area. Hence, as indicated by the above Table 1, when the UE does not require the MT service, performing the N-TAU (i.e., Registration Area update) and the P-TAU (i.e., Reachability Update) may not be necessary for both the Limited mobility level and the Unlimited mobility level.

On the other hand, a UE that requires the MT service and is configured with the Unlimited mobility level may need both the N-TAU (i.e., Registration Area update) and the P-TAU (i.e., Reachability Update) and may need the paging procedure.

Further, a UE that requires the MT service and is configured with the Limited mobility level may need the P-TAU (i.e., Reachability Update) but may not need the N-TAU (i.e., Registration Area update) in which the TA is changed, and may need the paging procedure.

### Embodiment 2) Operation of a UE that Requires Limited Area/MT Service

According to an embodiment of the present invention, when a mobility level of a UE is a Limited Area, the corresponding UE may not perform Registration area update. This is described with reference to the following Figure.

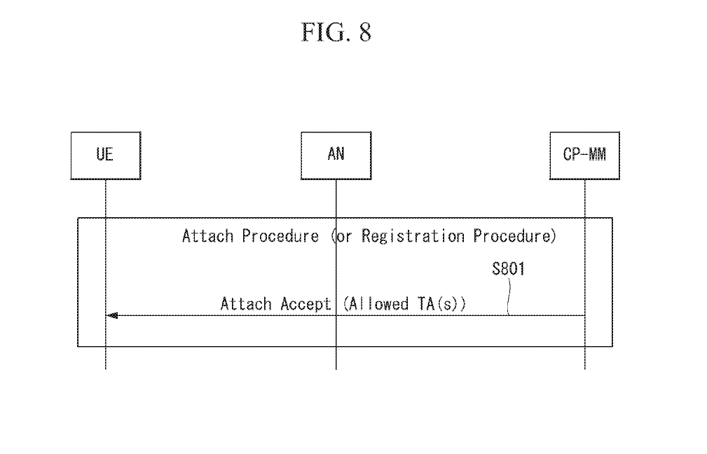

FIG. 8 illustrates an attach procedure (or registration procedure) of a UE, with which a limited mobility level is configured, in accordance with an embodiment of the present invention.

In FIG. 8, AN may correspond to the above-described 5G-AN, and CP-MM may correspond to AMF.

Referring to FIG. 8, a UE performs an attach procedure (or registration procedure) with the CP-MM (or AMF) via the AN.

If a network (e.g., CP-MM or AMF) recognizes that a mobility level of the UE is a Limited Area by subscribed information, etc. during the attach procedure of the UE, the network transmits an Attach Accept message together with (or including) area information to which services of the UE are allowed (S801).

Herein, the transmission of the allowed area information can be implemented by including allowed TA(s) in the Attach accept message.

The UE conforms that the allowed TA(s) are included in the Attach accept message or a similar message, and may not perform a Registration area update procedure thereafter.

However, if MT service is supported (or if the MT service is allowed from the network), the UE can perform Reachability update and paging reception operations for Reachability update.

If the UE does not perform the Reachability update on time, the UE can start an implicit detach timer and initiate a detach operation. For example, the network (e.g., CP-MM or AMF) can drive a reachability-related timer when a connection such as NAS signaling connection with the UE is released. If the UE does not perform the Reachability update until the reachability-related timer expires, the network can start the implicit detach timer. If the UE does not perform the Reachability update until the implicit detach timer expires, the network can implicitly detach the UE.

Even if the UE leaves its Allowed TA(s), the UE can perform the Reachability update procedure by the network configuration. However, even in this case, if the UE leaves its Allowed TA(s), the UE may not perform an operation to receive services from the network, for example, a service request procedure.

### Embodiment 3) Operation of a UE that Does Not Require MT Service

According to an embodiment of the present invention, a UE that does not require MT service (i.e., UE that requires only MO service) may not perform both Registration area update and reachability update operations regardless of whether a mobility level of the UE is a limited or an unlimited.

Further, in case of the UE that does not require the MT service, because paging reception necessary for the MT service is not necessary, paging monitoring is not required.

An example of the UE may correspond to a UE that is connected (registered) with a 5G core network over a non-3GPP access network (e.g., WLAN).

Hereinafter, for convenience of explanation, a UE that is connected (registered) with the 5G core network over a 3GPP access network is referred to as a 3GPP UE, and a UE that is connected (registered) with the 5G core network over the non-3GPP access network (e.g., WLAN) is referred to as a non-3GPP UE.

In an existing EPS, a 3GPP core network did not perform mobility management for a non-3GPP UE, and thus an MME did not perform mobility management for the non-3GPP UE. Hence, because the non-3GPP UE was not managed at the EPS, handover, etc. was impossible.

A 5G system architecture has minimized dependency between the AN and the CN and has introduced a converged access-agnostic concept that converges different cellular types (i.e., 3GPP and non-3GPP access (e.g., WLAN) types).

Hence, an AMF in a 5G core network may apply an operation (e.g., registration, connection state management) similar to an operation for controlling the 3GPP UE in the old EPS while controlling the non-3GPP UE.

Namely, in a 5G system, both the 3GPP UE (via the 3GPP access network) and the non-3GPP UE (via the non-3GPP access network and N2IWF) may be connected to the AMF via N2 corresponding to Si that is a connection interface between the MME and the eNB in the EPS (see FIGS. 1 and 7).

In case of the non-3GPP UE in the existing EPS, because S1 signaling connection was not present, it was implicitly regarded as an EMM-DEREGISTERED state if a PDU session was released. In this instance, there is a problem that frequent registration/re-registration occurs due to mobility of the UE, etc.

In the 5G system, because the non-3GPP UE is connected to the AMF via the N2 interface in the same manner as the 3GPP UE, an operation controlling the non-3GPP UE may be applied to the AMF, similar to the 3GPP UE.

For example, in order to prevent the frequent registration/re-registration of the non-3GPP UE, even in case of the non-3GPP UE, it does not transition to a RM-DEREGISTERED state immediately when signaling connection is released, and a CM-IDLE state may be defined in a RM-REGISTERED state. In other words, even if the UE re-enters a registration area again in a short time after leaving the registration area or a non-3GPP access area, it is to prevent the frequent registration/re-registration from being performed.

In this instance, the non-3GPP UE in the CM-IDLE state may operate as follows.

In case of the non-3GPP UE (i.e., the UE registered with the network over the non-3GPP access), the registration area for the non-3GPP access corresponds to a unique reserved Tracking Area Identity (TAI) (i.e., dedicated to the non-3GPP access). Thus, there is a unique Tracking Area for the non-3GPP access to 5GC. This is a value equally corresponding to an area of a corresponding PLMN, and as a result the non-3GPP UE may not perform the Registration Area update.

The UE may not perform the Periodic Registration update (or Reachability update) over the non-3GPP access, and a periodic registration timer may not be provided to the UE for the non-3GPP access.

Further, the UE may not be paged over the (untrusted) non-3GPP access.

After all, the non-3GPP UE in the CM-IDLE state may correspond to an example of the UE that does not require the MT service in the above Table 1.

As described above, the non-3GPP UE may not perform Registration Area update and periodic Registration Area update (or Reachability update) in the CM-IDLE state. Hence, there is a problem that the network cannot confirm whether a corresponding UE has been detached and when the corresponding UE has been detached.

In order to solve the problems, the present invention proposes an operation of the UE that does not require the MT service (e.g., the UE registered with the network over the non-3GPP access).

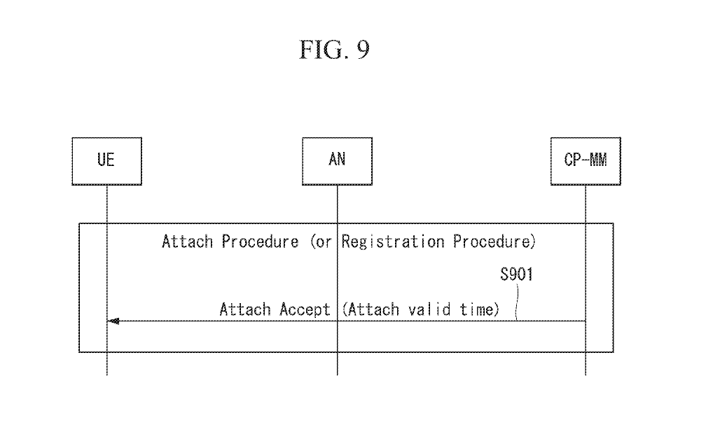

FIG. 9 illustrates an attach procedure (or registration procedure) of a UE that does not require MT service in accordance with an embodiment of the present invention.

n FIG. 9, AN may correspond to the above-described 5G-AN, and CP-MM may correspond to AMF.

Referring to FIG. 9, a UE performs an attach procedure (or registration procedure) with the CP-MM (or AMF) via the AN.

A network (e.g., CP-MM or AMF) transmits an Attach Accept message together with (or including) an Attach valid time when transmitting the Attach Accept message to a corresponding type of UE (S90).

Herein, the Attach valid time corresponds to a timer for managing a DEREGISTERED state of a UE that does not require MT service (e.g., a UE registered with the network over the non-3GPP access). However, the present invention is not limited thereto. The Attach valid time may be referred to as another name (e.g., Implicit Deregistration timer).

The Attach valid time may be reset when the corresponding UE enters a connected mode (i.e., CM-CONNECTED state). The Attach valid time runs when the connected mode (i.e., CM-CONNECTED state) of the UE ends (i.e., when the UE enters an Idle mode (i.e., CM-IDLE state)).

For example, in case of the (untrusted) non-3GPP access to SGC, when Nwu signaling connection between the UE and N3IWF is released, it may be interpreted that the UE transitions to the CM-IDLE state and maintains a RM-REGISTERED state. Thus, if the Nwu signaling connection is released, the timer may be driven.

Hence, if a corresponding Attach valid time has not expired in next MO service (i.e., when data to be transmitted to the network is generated), the UE can perform a service request operation. On the other hand, if a corresponding Attach valid time has already expired in the MO service (i.e., when data to be transmitted to the network is generated), the UE performs an Attach operation and performs the MO service.

Namely, after the Attach valid time expires, the network can perform implicit detach. Hence, after the Attach valid time expires, the UE can transmit an Attach Request message to the network and then perform again a Service Request procedure.

In the instance, the network may configure a sufficient long time as the Attach valid time for the UE.

In another embodiment, an Attach valid time is not reset upon transition to a connected mode and may be implemented as time requiring Re-attach of the UE after the Attach. Namely, after the UE re-attempts the Attach procedure when the Attach valid time expires and then the MO service is requested, the UE can perform the Service Request procedure.

As described above, when the UE that does not require the MT service has an Unlimited mobility level, the UE can perform the Service Request procedure before the Attach valid time. This is described with reference to the following figures.

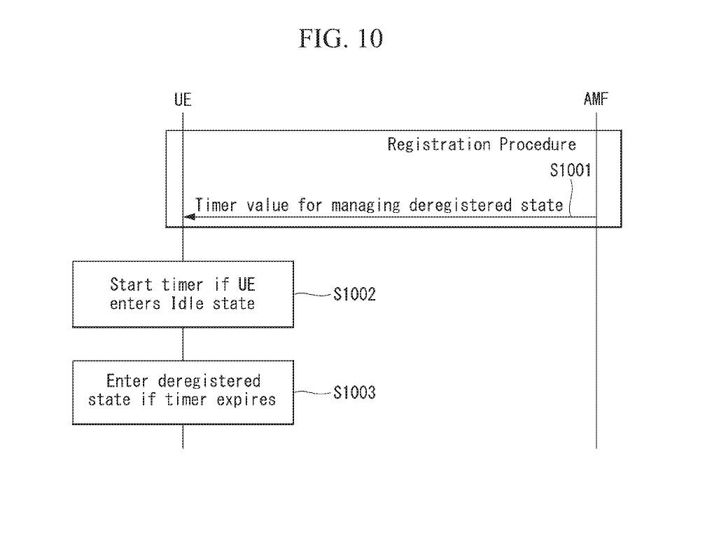

FIG. 10 illustrates a mobility management method according to an embodiment of the present invention.

Referring to FIG. 10, the UE receives a timer value (i.e., attach valid time) for managing a Deregistered state from the AMF (or CP-MM) during a registration procedure (S1001).

As described above, the UE may correspond to a UE that cannot be paged by the network and does not perform periodic Registration Area update (or reachability update) (e.g., UE registered with the network over the non-3GPP access).

If the UE enters an Idle state (i.e., CM-IDLE state), the UE starts a timer (S1002).

For example, in case of the (untrusted) non-3GPP access to 5GC, when Nwu signaling connection between the UE and N3IWF is released, it may be interpreted that the UE transitions to the CM-IDLE state and maintains a RM-REGISTERED state. Thus, if the Nwu signaling connection is released, the timer may be driven.

If the timer expires, the UE enters a Deregistered state (S1003).

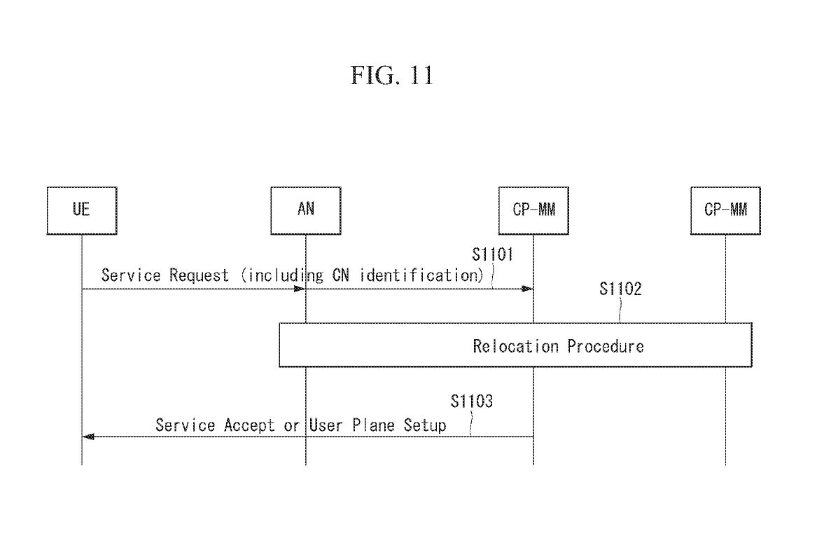

FIG. 11 illustrates a CN relocation procedure triggered by a service request in accordance with an embodiment of the present invention.

In FIG. 11, AN may correspond to the above-described 5G-AN, CP-MM may correspond to AMF, and CP-SM may correspond to SMF.

When a UE that does not require MT service has an Unlimited mobility level, the UE performs a Service Request procedure before an Attach valid time (S1101). Namely, the UE initiates the Service Request procedure by transmitting a Service Request message to the CP-MM (or AMF).

In this instance, the UE may transmit the Service Request message by including identification information of a serving CN node of the UE in the Service Request message.

This is to enable CN relocation when the UE leaves a serving CN area due to a movement of the UE if the UE performs the Service Request procedure before the Attach valid time.

If it is determined that the relocation of the CP node (i.e., CP-MM or AMF) receiving the Service Request message from the UE is necessary (i.e., if a new CP node has to receive context information of the UE from an old CP node because an access node of a current location of the UE cannot service to an old serving CP node of the UE), the UE can perform a Relocation procedure together with the Service Request procedure (S1102).

Hence, after the relocation of the CP node is completed, a procedure according to the Service Request may be subsequently performed.

If the Service Request procedure received from the UE is completed, the CP-MM (or AMF) transmits a Service Accept message or a User Plane Setup message to the UE (S1103).

In this instance, even in case of the UE having a Limited mobility level, CN delimiter (or identification) may be used as identification of the UE.

Overview of Devices to Which the Present Invention Can Be Applied

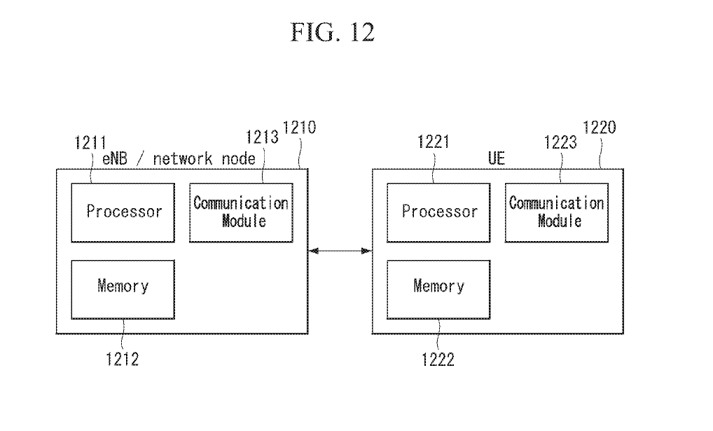

FIG. 12 illustrates a block diagram of a communication device according to an embodiment of the present invention.

With reference to FIG. 12, a wireless communication system comprises a network node 1210 and a plurality of UEs 1220.

A network node 1210 comprises a processor 1211, a memory 1212, and a communication module 1213. The processor 1211 implements proposed functions, processes and/or methods proposed through FIGS. 1 to 11. The processor 1211 can implement layers of wired/wireless interface protocol. The memory 1212, being connected to the processor 1211, stores various types of information for driving the processor 1211. The communication module 1213, being connected to the processor 1211, transmits and/or receives wired/wireless signals. Examples of the network node 1210 include network entities illustrated in FIG. 1 (e.g., AMF, SMF, (R)AN, UPF, PCF and so on). In particular, in case the network node 1210 is an eNB, the communication module 1213 can include a Radio Frequency (RF) unit for transmitting/receiving a radio signal.

The UE 1220 comprises a processor 1221, a memory 1222, and a communication module (or RF unit) 1223. The processor 1221 implements proposed functions, processes and/or methods proposed through FIGS. 1 to 11. The processor 1221 can implement layers of wired/wireless interface protocol. The memory 1222, being connected to the processor 1221, stores various types of information for driving the processor 1221. The communication module 1223, being connected to the processor 1221, transmits and/or receives wired/wireless signals.

The memory 1212, 1222 can be installed inside or outside the processor 1211, 1221 and can be connected to the processor 1211, 1221 through various well-known means. Also, the network node 1210 (in the case of an eNB) and/or the UE 1220 can have a single antenna or multiple antennas.

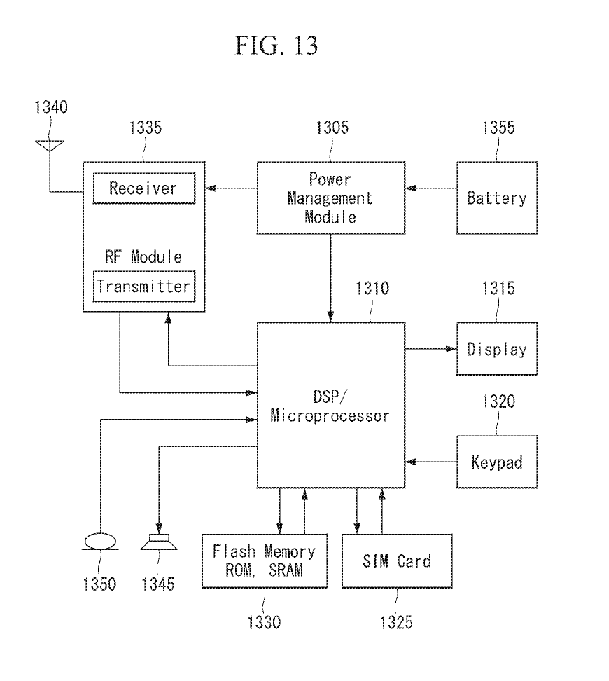

FIG. 13 illustrates a block diagram of a wireless communication device according to an embodiment of the present invention.

Particularly, in FIG. 13, the UE described above FIG. 12 will be exemplified in more detail.

Referring to FIG. 13, the UE includes a processor (or digital signal processor) 1310, an RF module (RF unit) 1335, a power management module 1305, an antenna 1340, a battery 1355, a display 1315, a keypad 1320, a memory 1330, a Subscriber Identification

Module (SIM) card 1325 (which may be optional), a speaker 1345, and a microphone 1350. The UE may include a single antenna or multiple antennas.

The processor 1310 may be configured to implement the functions, procedures and/or methods proposed by the present invention as described in FIGS. 1 to 11. Layers of a wireless interface protocol may be implemented by the processor 1310.

The memory 1330 is connected to the processor 1310 and stores information related to operations of the processor 1310. The memory 1330 may be located inside or outside the processor 1310 and may be connected to the processors 1310 through various well-known means.

A user enters instructional information, such as a telephone number, for example, by pushing buttons of the keypad 1320 or by voice activation using the microphone 1350. The microprocessor 1310 receives and processes the instructional information to perform the appropriate function, such as to dial the telephone number. Operational data may be retrieved from the SIM card 1325 or the memory module 1330 to perform the function. Furthermore, the processor 1310 may display the instructional and operational information on the display 1315 for the user's reference and convenience.

The RF module 1335 is connected to the processor 1310, transmits and/or receives an RF signal. The processor 1310 issues instructional information to the RF module 135, to initiate communication, for example, transmits radio signals comprising voice communication data. The RF module 1335 comprises a receiver and a transmitter to receive and transmit radio signals. An antenna 1340 facilitates the transmission and reception of radio signals. Upon receiving radio signals, the RF module 1335 may forward and convert the signals to baseband frequency for processing by the processor 1310. The processed signals would be transformed into audible or readable information outputted via the speaker 1345.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention may be achieved by various means, for example, hardware, firmware, software, or a combination thereof. In a hardware configuration, the methods according to the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. Software code may be stored in a memory unit and executed by a processor. The memory unit may be located at the interior or exterior of the processor and may transmit data to and receive data from the processor via various known means.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The present invention is applied to a 3GPP LTE/LTE-A and 5G systems is primarily described, but can be applied to various wireless communication systems in addition to the 3GPP LTE/LTE-A and 5G systems.

What is claimed is:

1. A method for managing registration performed by a User Equipment (UE), that cannot be paged by a network and does not perform a periodic registration area update, in a wireless communication system, the method comprising:
receiving a timer value for managing a Deregistered state of the UE from the network during a registration procedure;
starting a timer when the UE enters an Idle state; and
entering the Deregistered state when the timer expires.

2. The method of claim 1, further comprising, if the UE enters a Connected state from the Idle state, resetting the timer.

3. The method of claim 1, further comprising, if the timer does not expire upon generation of Mobile Originated data, initiating a service request procedure.

4. The method of claim 1, further comprising, if the timer has expired upon generation of Mobile Originated data, initiating the registration procedure.

5. The method of claim 1, wherein the UE is an UE configured with a Limited mobility level at which a service area is limited, or an Unlimited mobility level at which a service area is unlimited.

6. The method of claim 5, wherein the UE does not perform a registration area update procedure regardless of a mobility level of the UE.

7. The method of claim 1, further comprising, if the UE is configured with an Unlimited mobility level, initiating a service request procedure by transmitting a service request message including identification of a serving core network node.

8. The method of claim 1, wherein the UE is a UE that is registered with the network over a non-3GPP (3rd Generation Partnership Project) access.

9. A User Equipment (UE) for performing a registration management method in a wireless communication system, the UE comprising:
a communication module configured to transmit and receive a signal; and
a processor configured to control the communication module, wherein the processor is configured to:
receive a timer value for managing a Deregistered state of the UE from a network during a registration procedure,
start a timer when the UE enters an Idle state, and
entering the Deregistered state when the timer expires,
wherein the UE cannot be paged by the network and does not perform a periodic registration area update.
